(19) United States
(12) Patent Application Publication
(10) Pub. No.: US 2018/0015682 A1
(43) Pub. Date: Jan. 18, 2018

(54) FRONT STOPPING DEVICE, SHEET LAYERING DEVICE, COUNTER-EJECTOR, AND CARTON FORMER

(71) Applicant: MITSUBISHI HEAVY INDUSTRIES PRINTING & PACKAGING MACHINERY, LTD., Mihara-shi, Hiroshima (JP)

(72) Inventors: Shinya IORI, Mihara-shi, Hiroshima (JP); Osamu HATANO, Mihara-shi, Hiroshima (JP); Kazuya SUGIMOTO, Mihara-shi, Hiroshima (JP); Osamu YAMAMOTO, Mihara-shi, Hiroshima (JP)

(21) Appl. No.: 15/548,701

(22) PCT Filed: Jan. 21, 2016
(86) PCT No.: PCT/JP2016/051667

§ 371 Date: Aug. 3, 2017

(30) Foreign Application Priority Data
Feb. 9, 2015 (JP) 2015-023249

(51) Int. Cl. B65H 29/38; B65H 29/00; B65H 29/24

(52) U.S. Cl. CPC B31B 50/98; B65H 29/38; B65H 29/245; B65H 29/001; B31B 50/0012; B31B 50/042; B31B 50/88; B31B 2120/302; B31B 2110/35

(57) ABSTRACT

To stop a variety of sheets and prevent problems generated by colliding sheets, a front stopping device that receives sheets being delivered along a horizontal transport route on a hopper unit and stops the movement in the transport direction includes a plate-shaped buffering member that is brought into direct contact with the front part of a sheet; and supporting members that support the upper end and lower end of the buffering member. The buffering member is formed of a flexible material to absorb the kinetic energy of the sheet by being elastically deformed in a concave surface shape when receiving the front part of the sheet, and the buffering member is supported by being inclined upward or downward by the supporting members such that a restoring force of pushing back the front part of the sheet due to the restoration of the elastic deformation includes a vertical component.

### TECHNICAL FIELD

The present invention relates to a front stopping device that is suitable to be used for a counter-ejector that collects and counts corrugated cartons provided in the most downstream part of a carton former and discharges the corrugated cartons in a batch, and a sheet layering device, a counter-ejector, and a carton former using this same.

### BACKGROUND ART

Carton formers for manufacturing corrugated cartons are provided with a counter-ejector that collects, counts, and layers sheet-like corrugated cartons (hereinafter also referred to as sheets) formed in the most downstream part of a carton former and discharges the corrugated cartons in a batch with a predetermined number of sheets. This counter-ejector has a hopper that layers sheets, stops the movement, in a transport direction, of a sheet delivered upward of the hopper horizontally or substantially horizontally from delivery rollers, using a front stopper (front abutment plate), and drops the sheet onto the hopper to layer a predetermined number of sheets.

Since a leading end of the sheet delivered substantially horizontally onto the hopper collides against the front stopper, there is a concern that the leading end of the sheet may be damaged or the front stopper itself may be damaged. Moreover, in recent years, high speed is proceeding even in the carton former, and the leading end of the sheet collides against the front stopper at a higher speed. Therefore, a concern regarding such damage becomes more remarkable. Thus, techniques concerning the front stopper adapted such that the durability of the front stopper itself is also improved while buffering the collision of the leading end of the sheet have been developed.

For example, PTL 1 discloses a front stopper having a protective plate that collides against a leading end of a sheet, a plate spring that abuts against a back surface of a protective plate, and a supporting plate that is provided on the back surface of the plate spring via sponge rubber. The protective plate is made of rigid resin, the plate spring is made of metal, and the supporting plate is made of steel. The protective plate is installed with a surface receiving the leading end of the sheet being directed to a vertical direction so as to confront the sheet that is substantially horizontally transported.

Since the protective plate is made of rigid resin and is elastically supported from the back surface thereof by the plate spring, the sheet is stopped while the protective plate is displaced according to the elastic deformation of the plate spring if the leading end of the sheet collides against the protective plate. For this reason, the sheet can be stopped while avoiding damage to the protective plate and the sheet. Additionally, since the supporting plate, which supports the protective plate and the plate spring from the back surface thereof, is fixed with play in a contactless manner with the protective plate and the plate spring, stress concentration is relaxed and the durability of the front stopper itself is improved.

Additionally, PTL 2 discloses that, although not a front stopper of a counter-ejector of a carton former, in a stacker device for rejecting a postcard, an inclined plate (equivalent to the front stopper) inclined slightly upward with respect to a vertical direction is provided at a portion that collides against a leading end of a carried-in postcard, and a roller is provided at an upper part of the inclined plate. If the leading end of the postcard collides against the inclined plate, the leading end of the postcard moves upward along the inclined plate, and a portion slightly behind the leading end of the postcard strikes the roller and the upward movement thereof is restricted. Accordingly, the postcard rotates about a position where the leading end of the postcard has struck the roller and falls in a tail-dropped stable posture.

### CITATION LIST

### Patent Literature

[PTL 1] Japanese Unexamined Patent Application Publication No. 2010-52356

[PTL 2] Japanese Unexamined Patent Application Publication No. 10-236711

### SUMMARY OF INVENTION

### Technical Problem

Meanwhile, in the carton former, various sheets like a heavy sheet, a light sheet, a sheet that is long in the transport direction, a sheet that is short in the transport direction, a high-rigidity sheet, or a low-rigidity sheet are manufactured according to order in one machine. Thus, such various sheets collide against the front stopper of the counter-ejector.

If a heavy sheet or a rigid (high-rigidity in the transport direction) sheet is used, the colliding impact of the front stopper is large. Therefore, the front stopper must also be able to sufficiently absorb the impact to the heavy sheet. In order to absorb the large impact, it is effective to use, for example, the elastic deformation of an elastic body like the plate spring of PTL 1. The inclined plate of PTL 2 does not use the elastic deformation, and cannot sufficiently absorb the impact of a sheet, which is heavier than a postcard, like a corrugated carton. However, if the elastic deformation of the elastic body is used, the elastic body is necessarily restored. Therefore, there is a concern that the sheet may be largely bounced against its traveling direction due to this restoring force and sheets may not be easily aligned during layering.

Additionally, since the sheet is sandwiched and delivered by the delivery rollers disposed on an upstream side of an upper part of the hopper in the transport direction, the sheet is delivered in a state where a rear end side thereof is constrained by the delivery rollers and a front end side is free. For this reason, in the case where a flexible (a sheet having a low rigidity in the transport direction), the sheet collides against the front stopper in a state where the front end side that is a free end hangs downward, that is, is inclined forward. Moreover, if a sheet is longer in the transport direction, the forward inclination becomes more conspicuous.

Since the rear end of the sheet is at a high position in the state of the forward inclination, a front end of the following sheet collides against the rear end of the sheet stopped by the front stopper and damage such that each sheet bends is caused or jamming of a layering part is caused. Thus, there is a concern that a sheet cannot be appropriately stacked. A technique of providing a blower above the vicinity of the delivery rollers and pressing a rear end of a sheet downward with wind pressure is known. However, even if this is used, the wind pressure acts on the rear end of the sheet after the rear end of the sheet escapes from the delivery rollers. Thus, if the transporting speed of the sheet is fast, the following sheet may enter before the wind pressure acts on the rear end of the sheet. Thus, the collision of the following sheet cannot be sufficiently avoided.

Additionally, in the sheet that is short in the transport direction or a relatively rigid sheet, there is a case where the wind pressure may act on the rear end of the sheet, and contrary to the above, the sheet may collide against the front stopper in a tail-dropped state (backward-inclined state). As a result, a concern that sheets cannot be appropriately stacked occurs. It is difficult to solve the above problems in the technique of PTL 1.

The invention has been invented in view of such problems, and an object thereof is to provide a front stopping device adapted to stop a variety of sheets while absorbing the impact and to prevent problems generated by sheets colliding against a front stopper in a forwardly or backwardly inclined state, and a sheet layering device, a counter-ejector, and a carton former using this same.

### Solution to Problem

(1) In order to achieve the above object, a front stopping device of the invention is a front stopping device that receives a front part of a sheet delivered to a space above a hopper unit along a horizontal or substantially horizontal transport route by a delivery roller and stops movement of the sheet in a transport direction. The front stopping device includes a plate-shaped buffering member that is brought into direct contact with the front part of the sheet; and a supporting member that supports an upper end and a lower end of the buffering member. The buffering member is formed of a flexible material to absorb the kinetic energy of the sheet by being elastically deformed in a concave surface shape when receiving the front part of the sheet. The buffering member is supported by being inclined upward or downward by the first supporting member such that a restoring force of pushing back the front part of the sheet due to the restoration of the elastic deformation includes a vertical component.

(2) It is preferable that the buffering member is supported by being inclined vertically upward by the first supporting member.

(3) It is preferable that the buffering member includes a plate-shaped elastic member that is brought into direct contact with the front part of the sheet, and a flat spring that is disposed on a back surface of the elastic member and is deformed together with the elastic member at the time of deformation of the elastic member.

(4) It is preferable that a deformation-allowing space that allows elastic deformation caused by the collision of the sheet is provided on the back surface of the buffering member.

(5) It is preferable that the buffering member is fixed at a predetermined inclination angle by the first supporting member.

(6) It is preferable that the first supporting member is provided with an inclination angle adjusting mechanism that adjusts an inclination angle of the buffering member.

(7) It is preferable that the inclination angle adjusting mechanism includes a supporting shaft that supports one of the upper end and the lower end of the buffering member so as to be turnable around an axis that is orthogonal to the transport direction, and is horizontal, and a moving mechanism that moves the other end of the upper end and the lower end of the buffering member in the transport direction.

(8) It is preferable that the inclination angle adjusting mechanism includes manual operation means for moving a main part of the buffering member.

(9) It is preferable that the inclination angle adjusting mechanism includes an actuator that moves a main part of the buffering member.

(10) It is preferable that the front stopping device further includes control means for controlling the actuator according to input of the type of sheet and processing conditions of the sheet and automatically sets the inclination angle of the buffering member.

(11) It is preferable that the buffering member is split into a plurality of portions in a device width direction, and wherein inclination angle adjusting mechanisms are individually provided at the respective split portions.

(12) It is preferable that the buffering member is split into a plurality of portions in a device width direction, and wherein an interlocking mechanism is provided to be capable of integrally interlocking the respective split portions with each other to adjust the inclination angle using the inclination angle adjusting mechanism.

(13) A sheet layering device of the invention is a sheet layering device including a hopper unit that layers a sheet horizontally or substantially horizontally; a delivery roller that delivers the sheet to a space above the hopper unit along a horizontal or substantially horizontal transport route; and a front stopper part that receives a front part of a sheet delivered by the delivery roller and stops movement of the sheet in a transport direction. The front stopper part is provided with the front stopping device.

(14) It is preferable that the sheet layering device further includes a sheet pressing device that suppresses a rear part of the sheet delivered by the delivery roller downward, and the sheet pressing device includes a pressing roller that is disposed downstream of the delivery roller, comes into contact with the sheet, and rotates together with the movement of the sheet, and a second supporting member that supports the pressing roller so as to be rockable between the inside of the transport route and a space above the transport route.

(15) It is preferable that the sheet layering device further includes a blowing device that is disposed above the hopper unit and blows air against the sheet delivered by the delivery roller downward from above.

(16) It is preferable that the sheet is a sheet-like corrugated carton.

(a) It is preferable that the second supporting member is provided with an energizing member that is set such that the pressing roller is moved upward of the transport route by abutment of the sheet, and energize the pressing roller such that the pressing roller enters the transport route, when the sheet, which has entered the transport route, is supported by the delivery roller.

(b) It is preferable that the pressing roller includes a first pressing roller close to the delivery roller, and a second pressing roller far from the delivery roller, rotation centers of the first pressing roller and the second pressing roller are disposed such that a lower part of the first pressing part enters the transport route and a lower part of the second pressing roller enters the transport route further than the lower part of the first pressing roller, in a state where the sheet supported by the delivery roller does not abut thereagainst, and the second pressing roller is set so as to be moved to an upper side within the transport route or upward of the transport route if the first pressing roller is moved upward the transport route by the abutment of the sheet.

(c) It is preferable that a plurality of the sheet pressing devices are provided in a device width direction.

(d) It is preferable that the second supporting member includes a rocking arm that rotatably supports the pressing roller, and an air cylinder that supports the rocking arm to cancel dead weights of the pressing roller and the supporting arm.

(e) It is preferable that the second supporting member includes a rocking arm that rotatably supports the pressing roller, and a mechanical spring that elastically supports the rocking arm to function as the spring member.

(f) It is preferable that the second supporting member is connected to evacuation operating means that evacuates the pressing roller upward in the transport route.

(g) It is preferable that the pressing roller is formed of rubber or resin.

(h) It is preferable that the pressing roller has a hollow part formed at least in the vicinity of a peripheral surface thereof, or is formed in a sponge shape.

(i) It is preferable that a width of the pressing roller is larger than a slotter width of the sheet-like corrugated carton.

(17) A counter-ejector of the invention, which is provided at a downstream part of a carton former, includes the sheet layering device. The counter-ejector layers a sheet-like corrugated carton, which is transported and delivered from an upstream side, on the hopper unit, while counting the sheet-like corrugated carton.

(18) A carton former of the invention is a carton former including a sheet feeding section that feeds corrugated fiberboards one by one; a printing section that performs printing on a corrugated fiberboard fed from the sheet feeding section; a slotter creaser section that discharges the corrugated fiberboard printed by the printing section; a die-cut section that performs grooving and ruling on the corrugated fiberboard discharged from the slotter creaser section; a folder-gluer section that performs gluing and bending on an end of the corrugated fiberboard processed by the die-cut section to form a sheet-like corrugated carton; and a counter-ejector section that layers the corrugated carton processed by the folder-gluer section while counting the corrugated carton. The counter-ejector section is provided with the counter-ejector according to claim 17.

### Advantageous Effects of Invention

According to the front stopping device of the invention, the buffering member is formed of a flexible material and is elastically deformed in a concave surface shape to absorb the kinetic energy of the sheet. Thus, the movement of the sheet in the transport direction can be stopped while efficiently absorbing the impact of the sheet. Since the buffering member is supported by being inclined upward or downward by the first supporting member, and the restoring force of pushing back the front part of the sheet due to the restoration of the elastic deformation includes a vertical component. As a result, in a case where the sheet is inclined forward or backward to collide against the buffering member, the vertical component of the restoring force corrects the inclination of the sheet. Accordingly, various problems caused by the sheet being inclined forward or backward to collide against the buffering member are avoided.

Additionally, the buffering member is supported by being inclined upward or downward by the first supporting member, and the restoring force of pushing back the front part of the sheet due to the restoration of the elastic deformation includes the vertical component. As a result, the restoring force of pushing back the front part of the sheet in the horizontal direction, that is, the momentum opposite to a traveling direction of the sheet becomes weaker correspondingly, and sheets are easily aligned during layering.

### BRIEF DESCRIPTION OF DRAWINGS

FIG. 1 is a side view illustrating an overall configuration of a sheet layering device and a counter-ejector related to a first embodiment of the invention (a view illustrating the inside of the counter-ejector with frames on a near side removed).

FIG. 2 is a side view illustrating the configuration of a carton former including the counter-ejector related to the first embodiment of the invention.

FIG. 3 is a perspective view illustrating a folder-gluer section of the carton former and a hopper portion of a counter-ejector section related to the first embodiment of the invention.

FIG. 4 is a side view illustrating a front stopping device related to the first embodiment of the invention.

FIGS. 5A to 5D are schematic side views illustrating the operation of the front stopping device related to the first embodiment of the invention in order of FIGS. 5A to 5D.

FIG. 6 is a schematic side view illustrating a sheet pressing device of the sheet layering device related to the first embodiment of the invention.

FIGS. 7A and 7B are schematic side views illustrating the sheet pressing device of the sheet layering device related to the first embodiment of the invention, FIG. 7A illustrates a state where a sheet is open and FIG. 7B illustrates a state where a sheet is sandwiched between and supported by delivery rollers.

FIGS. 8A to 8F are schematic side views illustrating the operation of the sheet pressing device of the sheet layering device related to the first embodiment of the invention in order of FIGS. 8A to 8F.

FIGS. 9A to 9C are views illustrating a front stopping device related to a second embodiment of the invention, FIG. 9A is a side view of the front stopping device and FIGS. 9B and 9C are enlarged views of main parts of the front stopping device.

FIG. 10 is a side view illustrating a front stopping device related to a third embodiment of the invention.

FIGS. 11A and 11B are views illustrating a front stopping device related to a fourth embodiment of the invention, FIG. 11A is a side view of the front stopping device and FIG. 11B is a plan view of a plurality of juxtaposed front stopping devices.

### DESCRIPTION OF EMBODIMENTS

Hereinafter, embodiments of the invention are described with reference to the drawings.

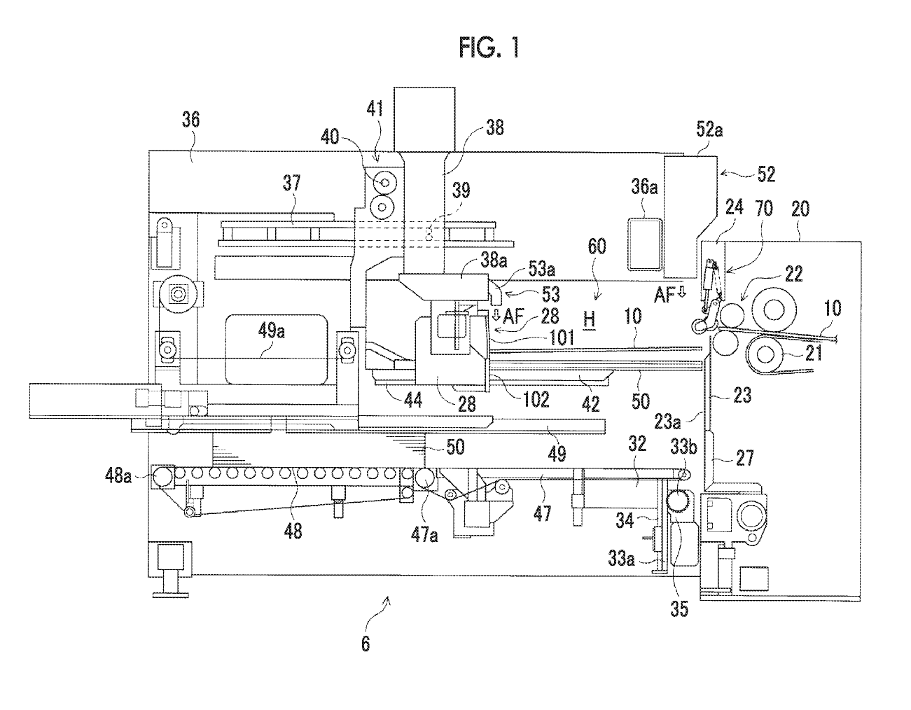

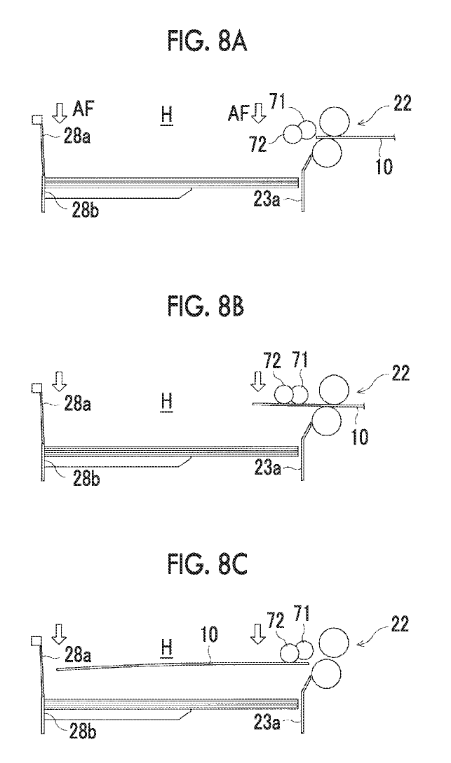

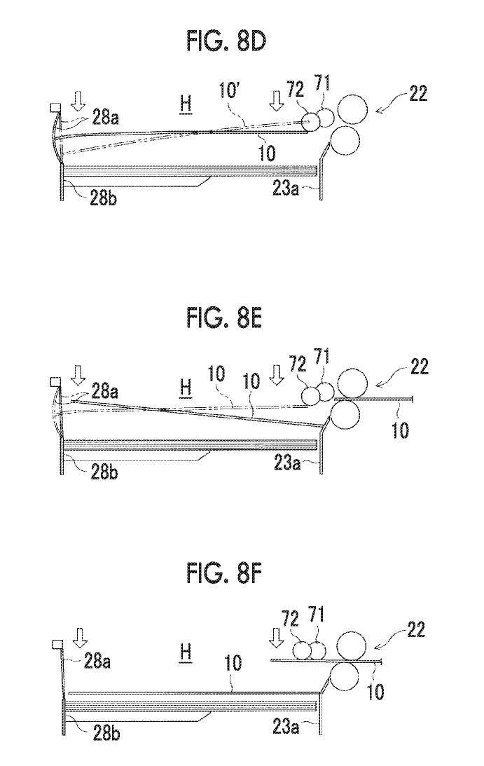

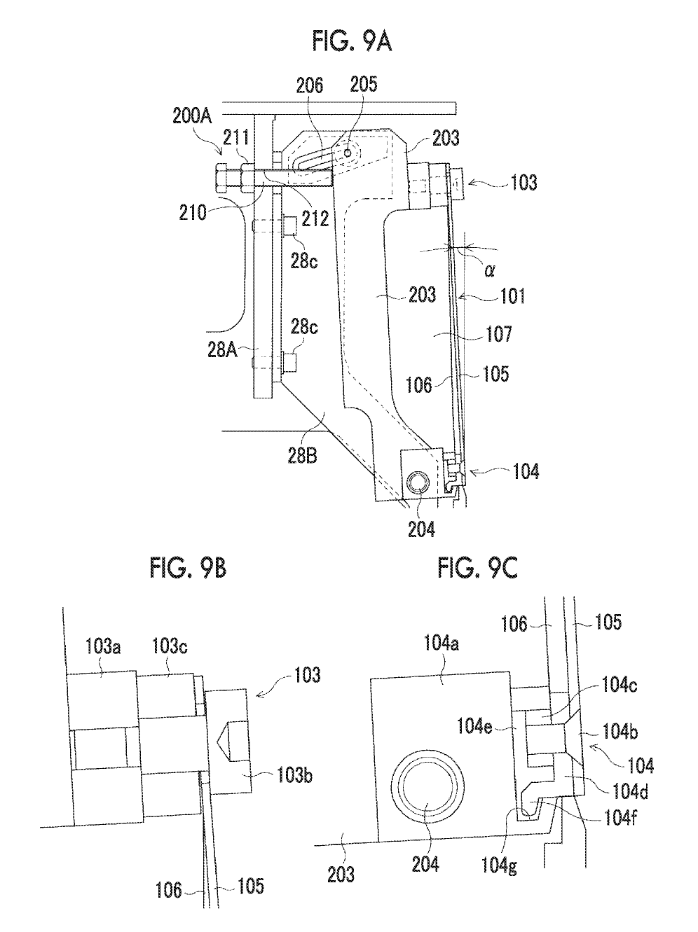

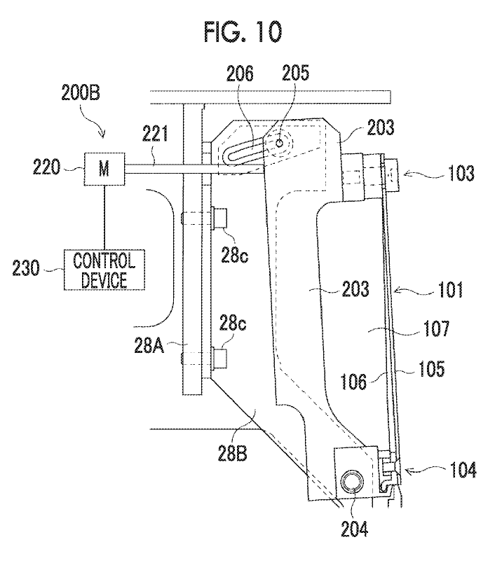

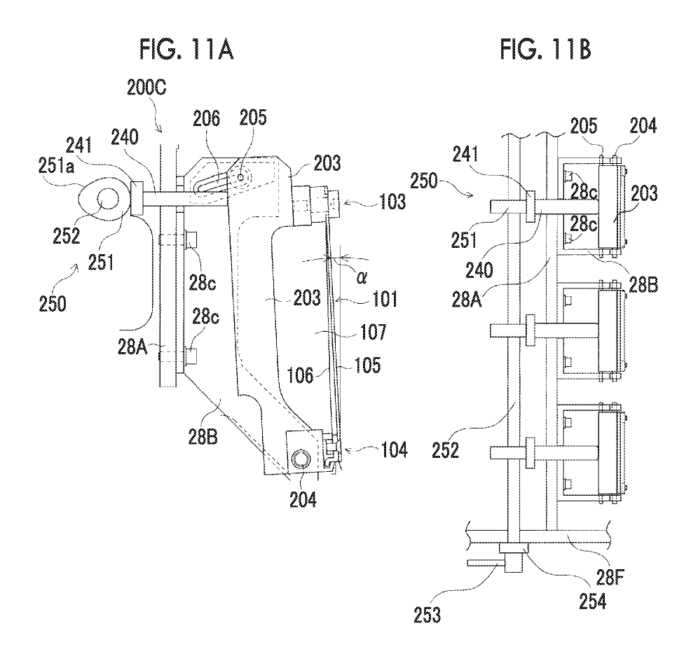

FIGS. 1 to 8 (FIGS. 8A to 8F) illustrate a front stopping device, a sheet layering device, a counter-ejector, and a carton former related to the first embodiment of the invention, FIGS. 9A to 9C illustrate a front stopping device related to a second embodiment of the invention, FIG. 10 illustrates a front stopping device related to a third embodiment of the invention and FIGS. 11A and 11B illustrate a front stopping device related to a fourth embodiment of the invention, and description is made on the basis of these drawings.

### First Embodiment

[Configuration of Carton Former]

First, the configuration of a carton former including a counter-ejector related to the present embodiment is described.

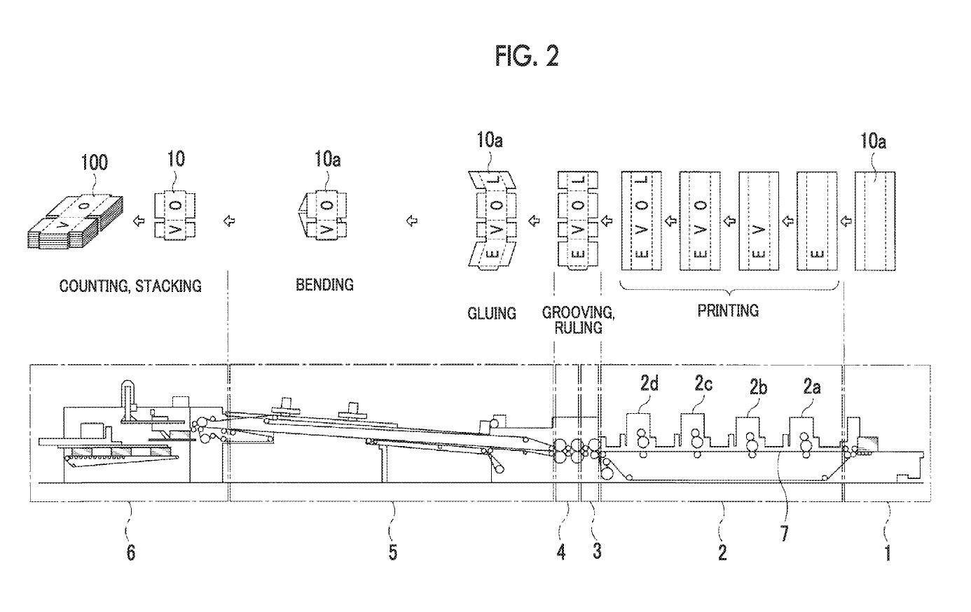

In FIG. 2, steps in which a corrugated fiberboard is processed into a sheet-like corrugated carton (a carton-forming sheet material or a sheet) are appended above device components in respective steps of a carton former in correspondence with the device components apart from the device components. As illustrated in FIG. 2, a sheet feeding section 1, a printing section 2, a slotter creaser section 3, a die-cut section 4, a folder-gluer section 5, and a counter-ejector section 6 are provided from an upstream side in this carton former.

In the sheet feeding section 1, a large number of plate-shaped corrugated fiberboards 10a is loaded in a stacked state, and the corrugated fiberboards 10a are supplied (fed) to the printing section 2 one by one.

The printing section 2 consists of printing units 2a to 2d with a predetermined number of colors (here, four colors). In the printing section 2, respective colors of ink are sequentially printed on corrugated fiberboards 10a transported one by one by a transporting conveyor 7.

In the slotter creaser section 3, the corrugated fiberboard 10a printed in the printing section 2 is discharged after grooving and ruling are performed thereon.

In the die-cut section 4, punching processing and further grooving and ruling are performed on the corrugated fiberboard 10a discharged from the slotter creaser section 3.

In the folder-gluer section 5, a gluing margin of one end, in a leftward-rightward direction, of the corrugated fiberboard 10a processed by the die-cut section 4 is glued, and both left and right ends of the corrugated fiberboard 10a are bent so as to overlap each other on back sides (lower sides) thereof. The corrugated fiberboard 10a processed by the folder-gluer section 5 has both the left and right ends glued together with glue and is turned into a sheet-like corrugated carton (carton-forming sheet material) 10.

The counter-ejector section 6 is a section in which the carton-forming sheet material 10 processed in the folder-gluer section 5 is stacked on a table (stacker table) while being counted. If a predetermined number of sheets of the carton-forming sheet material 10 is stacked by the counter-ejector section 6, this sheet material group 100 is shipped as a unit batch.

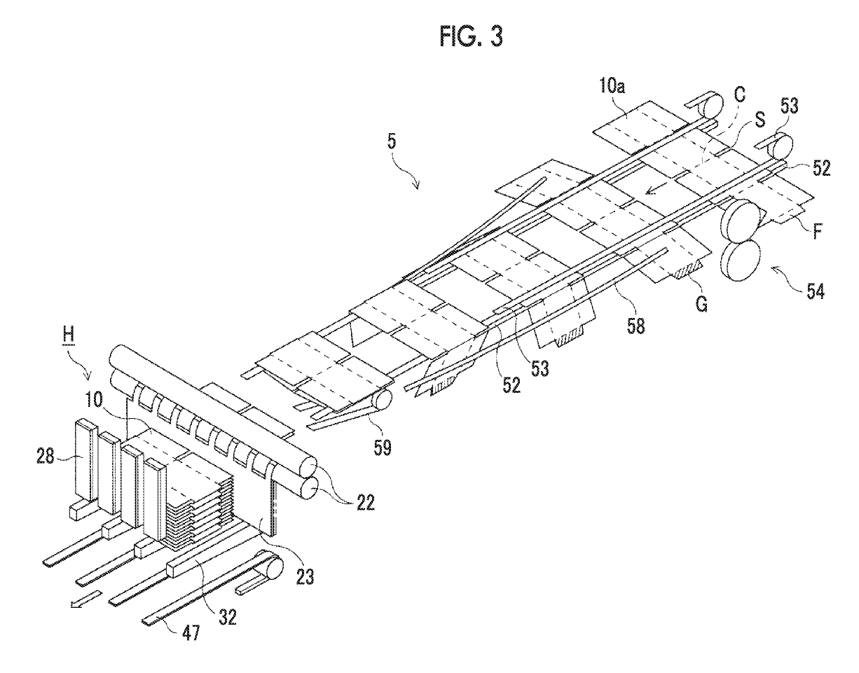

Moreover, an upstream part of the folder-gluer section 5 and the counter-ejector section 6, which are a rear half section of the carton former, is described with reference to FIG. 3. As illustrated in FIG. 3, in the slotter creaser section 3 and the die-cut section 4, the corrugated fiberboard 10a in which ruled lines C are processed and grooves S and a glue margin piece F are formed, is supported by guide rails 52 in the folder-gluer section 5, and is moved in the direction of an arrow while being sandwiched by a transport belt 53. Glue G (indicated by a diagonal line) is applied to the glue margin piece F by a glue application device 54. The corrugated fiberboard 10a to which the glue G is applied is folded up to 180° by a folding bar 58 while being moved.

After the folding, the glue margin piece F is pressed by the upper and lower delivery rollers 22 to ensure gluing, and the corrugated fiberboard 10a is delivered to a hopper unit H of the counter-ejector section 6. In this way, the corrugated fiberboard 10a is folded, glued, and turned into the sheet-like corrugated carton 10, is layered by the hopper unit H in the counter-ejector section 6, and is sorted into batches with a predetermined number of sheets.

[Sheet Layering Device and Counter-Ejector]

Next, the front stopping device 28, the sheet layering device 60 having the sheet pressing device 70, and the counter-ejector section (counter-ejector) 6 having the sheet layering device 60 is described with reference to FIG. 1. In addition, although the sheet layering device 60 including the sheet pressing device 70, for example, is illustrated in the present embodiment, the sheet pressing device 70 is not a constituent element that is indispensable in the sheet layering device 60 of the invention.

First, to describe the sheet layering device 60 provided at the counter-ejector 6, the sheet layering device 60 includes the hopper unit H in which the carton-forming sheet material 10, which is sheets, is layered, the delivery rollers 22, the front stopping device (simply also referred to as a front stopper) 28, blowing devices (fans) 52 and 53, and the sheet pressing device 70. In addition, the sheet pressing device 70, which is a device characteristic of the sheet layering device 60, is separately described.

As illustrated in FIG. 1, frames 20 are respectively erected on both sides, a machine width direction, of an entrance portion of the counter-ejector 6, and a roller 21 for an outlet part (rearmost part) conveyor of the folder-gluer section 5 and the pair of upper and lower delivery rollers 22 are attached to each frame 20. The delivery rollers 22 deliver the carton-forming sheet material 10 to a horizontal or substantially horizontal transport route while sandwiching the carton-forming sheet material 10 from above and below. A spanker 23 that presses an end of a stack (in which a plurality of sheets of the carton-forming sheet material 10 are layered) 50 to be described below is provided below the delivery rollers 22.

Although the spanker 23 has an abutting surface 23a against which a rear end of the carton-forming sheet material 10 abuts, and a portion below an intermediate part of the abutting surface 23a faces a vertical direction, an upper part of the abutting surface 23a is inclined such that an upper end shifts backward in a transport direction of the carton-forming sheet material 10.

Below an outlet side of the delivery rollers 22, a space where the stack 50 is formed serves as the hopper unit H as the carton-forming sheet material 10 being layered. The delivery rollers 22 deliver the carton-forming sheet material 10 onto a horizontal or substantially horizontal track (transport route) in a space above the hopper unit H.

Additionally, a flexible front stopper 28, which stops the carton-forming sheet material 10 being discharged from a folder-gluer 5 while decelerating the carton-forming sheet material 10, is supported at a facing position in front of the delivery rollers 22 so as to be movable in a forward-backward direction. That is, the front stopper 28 is provided so as to be movable in the forward-backward direction by a motor (not illustrated) with respect to a supporting part 38a of a ledge support 38. The front stopper 28 includes a flexible stop plate 101 formed of a flexible material in order to be elastically deformed by itself when a front part of the carton-forming sheet material 10 abuts thereagainst and to stop the movement of the carton-forming sheet material 10 in the transport direction while decelerating the carton-forming sheet material 10. Here, a high-rigidity stop plate 102 formed of, for example, a metallic high-rigidity material is provided below the flexible stop plate 101 in order to restrict the movement of the stack 50 at a front edge of the stack 50 when a rear end of the stack 50 is pressed by the spanker 23.

Additionally, an elevator 32, which has the stack 50 collected from a ledge 42 (to be described below) to a middle stage transferred thereto, receives the carton-forming sheet material 10, which has hit the front stopper 28 and has fallen therefrom, on the stack 50, and collects the carton-forming sheet material 10 to form the stack 50 with a predetermined number of sheets, is provided below the hopper unit H. The elevator 32 is disposed substantially horizontally below a portion in front of the delivery rollers 22 in the transport direction, is supported by a supporting shaft 34 provided with a rack 33a, and is configured so as to be reciprocable in an upward-downward direction by a driving mechanism consisting of the rack 33a, a pinion 33b to mesh with the rack 33a, and a servo motor 35 combined with the pinion 33b.

Side frames 36 are respectively provided on both sides in the machine width direction behind the hopper unit H in the counter-ejector 6, rails 37 are horizontally provided in the side frames 36, and the ledge support 38 described above is supported by the rails 37 on both sides so as to be capable of traveling. That is, the ledge support 38 is provided with a roller 39 that travels on each rail 37, a pinion (not illustrated) that meshes with a rack (not illustrated) provided along the rail 37, and a ledge back-and-forth servo motor 40 that rotationally drives this pinion, and the ledge support 38 is moved in the forward-backward direction by the normal and reverse rotation of the servo motor 40.

The ledge support 38 is provided with the ledge 42 that horizontally extends via a lifting mechanism 41. Although not illustrated, the lifting mechanism 41 consists of a rack-and-pinion mechanism, a ledge lifting servo motor that rotationally drives this pinion, and the like, and the ledge support 38 is lifted and lowered by the normal and reverse rotation of a servo motor.

The ledge 42 receives the carton-forming sheet material 10, which has hit the front stopper 28 and has fallen therefrom, to collect the carton-forming sheet material 10 to form the stack 50, has the carton-forming sheet material 10 transferred to the elevator 32 while the stack 50 is being formed, and then receives the carton-forming sheet material 10 in place of the elevator 32 in order to operate again and form the following stack 50 after the carton-forming sheet material 10 is further collected on the elevator 32 and the stack 50 reaches a set number of sheets.

A press bar 44 that presses the stack 50 is liftably supported on the ledge 42 so as to be capable of being lifted and lowered by a lifting mechanism (not illustrated). The lifting mechanism also consists of a rack-and-pinion mechanism (not illustrated), and a press bar lifting servo motor (not illustrated) that rotationally drives this pinion, and the press bar 44 is lifted and lowered by the normal and reverse rotation of a servo motor.

Fans (blowing devices) 52 and 53, which spray air AF downward from above on an upper surface of the carton-forming sheet material 10 delivered from the delivery rollers 22, are provided above the elevator 32 (namely, above the hopper unit H). The fans 52 are fixed fans (fixed blowing devices) fixed to a beam 36a supported by both the side frames 36, and the fans 53 are movable fans (movable blowing devices) that are fixed to the supporting part 38a supporting the front stopper 28 and that move in the forward-backward direction together with the front stopper 28.

In this example, all the fixed fans 52 are disposed at positions above the height level of the outlet of the delivery rollers 22 in the vicinity of upper ends of both the side frames 36, while the movable fans 53 are disposed at positions above the height level of the outlet of the delivery rollers 22 in the vicinity of an upper end of the front stopper 28.

Meanwhile, since the movable fans 53 at a front end in the transport direction approaches the carton-forming sheet material 10, the movable fans can partially blow strong wind to a front end of the carton-forming sheet material 10, and if the movable fans are used in a case where total air volume runs short only by the fixed fans 52, the moveable fans can be effectively used. Moreover, since the movable fans 53 are fixed to the front stopper side, the movable fans are adjusted such that the leading end of the sheet is automatically blown according to sheet length.

All the fans 52 and 53 are also adapted such that the blowing directions thereof face vertically downward, that is, a direction orthogonal to a substantially horizontal direction that is a right direction of a surface of the carton-forming sheet material 10 delivered from the delivery rollers 22, and all the fans 52 and 53 are also covered with ducts 52a and 53a and are adapted such that the blowing directions thereof face vertically downward while being straightened by the ducts 52a and 53a.

The counter-ejector 6 has such a sheet layering device 60, a function of layering and counting the carton-forming sheet material 10 on the hopper unit H of the sheet layering device 60, and the following discharge function of discharging carton-forming sheet material 10 layered by a predetermined number of sheets.

That is, a lower conveyor 47 is provided at the same height level as an upper surface of the elevator 32 when the elevator 32 is lowered to the maximum, and a discharge conveyor 48 is further provided at a height position at the same level as the lower conveyor 47 downstream of the lower conveyor. The lower conveyor 47 and the discharge conveyor 48 are respectively driven by a servo motor 47a for a lower conveyor, and a servo motor 48a for a discharge conveyor. An inlet tip position of the lower conveyor 47 should be located sufficiently close to a pusher 27 such that even a carton-forming sheet material 10 of a minimum length (transport direction length is a minimum) can be received, and thus is installed so as to enter the back of the elevator 32.

Moreover, an upper conveyor 49, which pinches the stack 50 together with the lower conveyor 47 and the discharge conveyor 48, and is supported above the lower conveyor 47 and the discharge conveyor 48 such that the position thereof in a height direction is capable of being adjusted via a moving mechanism 49a. Additionally, the upper conveyor 49 is movable also in the forward-backward direction, and is configured so as to move by a certain distance from the front stopper 28 in conjunction with the front stopper 28 in accordance with the carton size.

[Front Stopping Device]

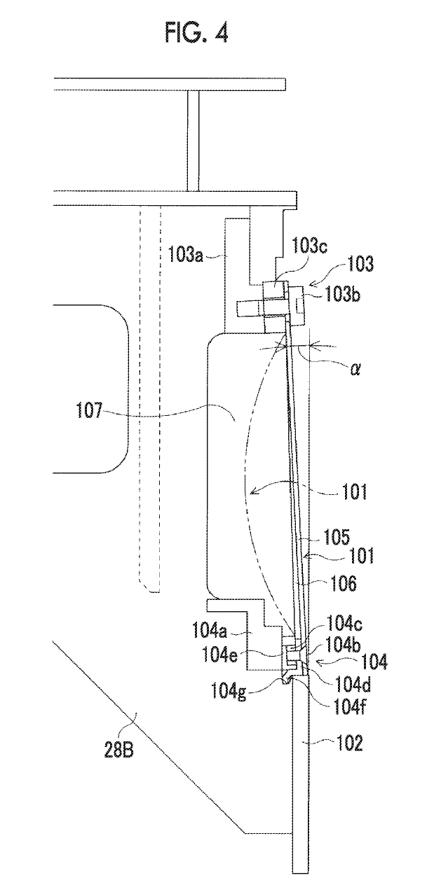

Here, the front stopper 28 is described with reference to FIG. 4. As illustrated in FIG. 4, the front stopper 28 has a flexible stop plate (plate-shaped buffering member) 101 that comes into direct contact with the front part of the carton-forming sheet material 10, and a high-rigidity stop plate 102 that is formed substantially continuously below the flexible stop plate. The flexible stop plate 101 has upper and lower ends supported by supporting members (first supporting member) 103 and 104.

The flexible stop plate 101 has a plate-shaped elastic member (elastic plate) 105 that comes into direct contact with the front part of the carton-forming sheet material 10, and a flat spring 106 that is disposed on a back surface of the elastic plate 105 and is deformed together with the elastic plate 105 at the time of the deformation of the elastic plate 105. Rigid rubber is applied to the elastic plate 105, and metallic materials, such as steel, are applied to the flat spring 106.

Here, although an upper end of the flat spring 106 comes into contact with the back surface of the elastic plate 105, a part lower than the upper end is configured so as to be gradually spaced apart from the back surface of the elastic plate 105. If the elastic plate 105 is elastically deformed so as to be curved in a concave surface shape to the back side thereof due to the collision of the carton-forming sheet material 10, not only the upper end of the flat spring 106 but also the part of the flat spring 106 lower than the upper end gradually comes into contact with the back surface of the elastic plate 105.

In a case where the elastic plate 105 is elastically deformed by itself so as to be curved to the back side thereof, an elastic reaction force (restoring force) becomes stronger according to the amount of deformation. However, in the configuration of the present embodiment, if the amount of deformation by which the elastic plate 105 is curvedly deformed to the back side thereof increases, the elastic reaction force of the flat spring 106 is added thereto to increase the elastic reaction force of the flexible stop plate 101. The elastic reaction force of the flat spring 106 becomes stronger according to an increase in the amount of deformation of the elastic plate 105.

The supporting member 103, which supports an upper end of the flexible stop plate 101, includes a supporting material 103a supported by a supporting base 28B fixed to the ledge support 38 or the like, and a bolt 103b fastened into a screw hole of the supporting material 103a, and the flexible stop plate 101 is fixed by fastening the bolt 103b inserted into a screw insertion hole formed at the upper end into the screw hole of the supporting material 103a. Here, a shortly-foamed or continuously-foamed sponge rubber 103c is interposed between the supporting material 103a and the flexible stop plate 101.

Although both the shortly-foamed sponge rubber and the continuously-foamed sponge rubber have an impact force absorption effect, in the case of the continuously-foamed sponge rubber, the air flows during deformation or a fine hole surface is squeezed during deformation, so that the continuously-foamed sponge rubber acts as a damper. Thus, the continuously-foamed sponge rubber is preferable because a larger impact force absorption effect is achieved. The internal diameters of screw insertion holes of the elastic plate 105 and the plate spring 106 have a play margin with respect to an outer shape of the bolt 103b. Additionally, an axial play margin is also given between a head part of the bolt 103b and the elastic plate 105.

The supporting member 104, which supports a lower end of the flexible stop plate 101, has a supporting material 104a supported by the supporting base 28B, a reinforcing member 104d fastened to lower ends of the elastic plate 105 and the plate spring 106 with a bolt 104b and a nut 104c and made of rigid resin, and a shortly-foamed or continuously-foamed sponge rubber 104e anchored to the nut 104c.

An upper part of the reinforcing member 104d is interposed between the elastic plate 105 and the plate spring 106, and the lower ends of the elastic plate 105 and the plate spring 106 are spaced apart from each other by the fastening between the bolt 104b and the nut 104c via the upper part of the reinforcing member 104d. A projection part 104f is formed at a lower part of the reinforcing member 104d, and the projection part 104f is fitted into a groove part 104g formed in the supporting material 104a with play. A certain degree of freedom is given to the movement of the lower part of the reinforcing member 104d.

In addition, the high-rigidity stop plate 102 is fixed to the supporting base 28B. Additionally, a surface (a surface on a hopper H side) of the high-rigidity stop plate 102 is disposed at a position that runs in a vertical direction or a substantially vertical direction and that is substantially continuously with a surface (a surface on the hopper H side) of a lower end of the flexible stop plate 101.

Meanwhile, the flexible stop plate 101 is supported by the supporting members 103 and 104 so as to be inclined slightly upward from the vertical direction. Here, the flexible stop plate 101 is inclined by an inclination angle α. In this way, the reason why the flexible stop plate 101 is inclined from the vertical direction is that a restoring force after the elastic deformation of the flexible stop plate 101 is used for correcting a forward-backward posture of the carton-forming sheet material 10.

As described in the section of the problems, the carton-forming sheet material 10 transported to an upper part of the hopper unit H by the delivery rollers 22 is sandwiched and delivered by the delivery rollers 22. Thus, the carton-forming sheet material is delivered in a state where a rear end side thereof is constrained by the delivery rollers 22 and a front end side thereof is free. In a case where the carton-forming sheet material 10 is flexible (the rigidity thereof is low in the transport direction), the carton-forming sheet material 10 collides against the flexible stop plate 101 in a state where the front end side that is a free end of the carton-forming sheet material 10 hangs downward, that is, is inclined forward. If the carton-forming sheet material 10 is longer in the transport direction, the forward inclination becomes more conspicuous.

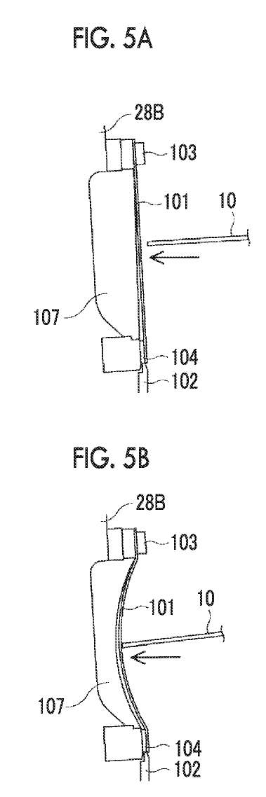

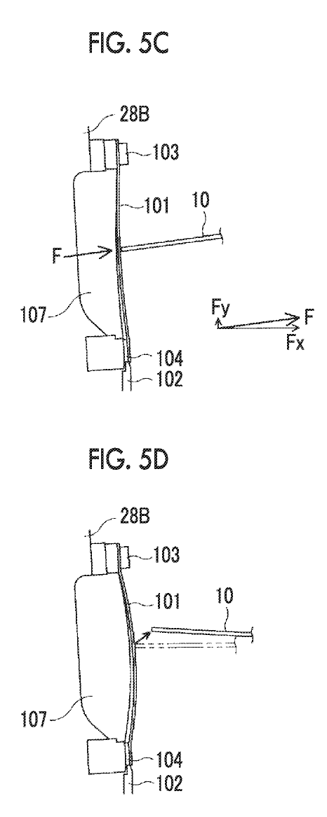

As illustrated in FIGS. 5A and 5B, if the carton-forming sheet material 10 collides against the surface of the flexible stop plate 101, the flexible stop plate 101 absorbs the kinetic energy of the carton-forming sheet material 10 to stop the movement of the carton-forming sheet material 10 in the transport direction while being elastically deformed so as to be curved in a concave surface shape to the back side thereof. Since the elastically deformed flexible stop plate 101 is restored afterward, as illustrated in FIG. 5C, the flexible stop plate 101 is pushed back to the carton-forming sheet material 10 in a direction opposite to the transport direction.

If the flexible stop plate 101 is inclined slightly upward with respect to the vertical direction, a restoring force F of the flexible stop plate 101 is generated, not in the horizontal direction, but in a slightly upward direction from the horizontal direction. That is, the restoring force F includes, not only a horizontal component Fx, but also a vertically upward component Fy. Since an upward force is applied to the front end of the carton-forming sheet material 10 by the vertically upward component Fy, and the front end of the carton-forming sheet material 10 is pushed back in a direction opposite to the transport direction and upward, the carton-forming sheet material 10 is corrected from the forwardly inclined posture to a posture that is horizontal in the forward-backward direction.

In addition, since the horizontal component Fx of the restoring force F decreases according to the vertically upward component Fy, a force of pushing back the carton-forming sheet material 10 in a direction opposite to the transport direction becomes weaker correspondingly, and unnecessary push-back of the carton-forming sheet material 10 is suppressed.

Additionally, the supporting base 28B or the like on the back side where the flexible stop plate 101 is curvedly deformed are provided with a deformation-allowing space 107 such that interference does not occur even if the flexible stop plate 101 is curvedly deformed. The deformation-allowing space 107 is obtained by forming the flexible stop plate 101 side of the supporting base 28B largely in a concave shape, and a collision load of the carton-forming sheet material 10 reaches a maximum. As a result, even if the flexible stop plate 101 is elastically deformed to the largest extent, the deformation-allowing space is sufficiently secured by such a size that this elastic deformation is allowed.

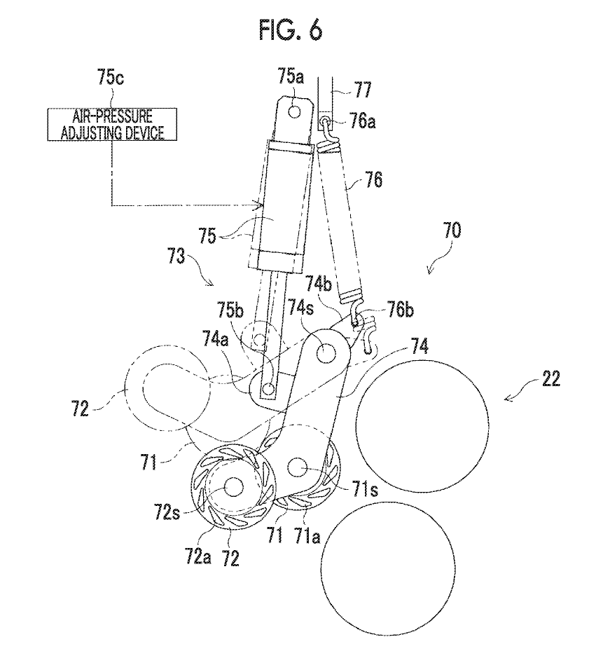

In addition, it is preferable that the flexible stop plate 101 is deformed as flexibly as possible, that is, as largely as possible to absorb the kinetic energy of the carton-forming sheet material 10 when stopping the carton-forming sheet material 10. The elastic property of the flexible stop plate 101 is set from such a viewpoint. Meanwhile, since the collision load of the carton-forming sheet material 10 is maximized according to the transporting speed and weight or rigidity of the carton-forming sheet material 10, the maximum level of the collision load of the carton-forming sheet material 10 can be assumed on the basis of this. The amount of maximum elastic deformation of the flexible stop plate 101 is calculated from the elastic property of the flexible stop plate 101 and the assumed maximum collision load of the carton-forming sheet material 10, and the deformation-allowing space 107 is secured by a size such that the elastic deformation is allowable.

[Sheet Pressing Device] Next, the sheet pressing device 70 is described with reference to FIG. 6. As illustrated in FIG. 6, the sheet pressing device 70 presses a rear part of the carton-forming sheet material 10 delivered by the delivery rollers 22 downward, to correct sinking of a leading end side of the carton-forming sheet material 10 to return the carton-forming sheet material 10 to a horizontal state. Here, two sheet pressing devices 70 are symmetrically disposed in a pair about a center in a device width direction and are provided to be supported by supporting beams (not illustrated) that bridge over both the frames 20 or both the side frames 36.

The two sheet pressing devices 70 are symmetrically formed, and each thereof includes two pressing rollers 71 and 72, and a supporting member (second supporting member) that supports the pressing rollers 71 and 72. The supporting member 73 has a supporting arm 74 having one end rockably supported by a shaft 74s on a supporting part (refer to FIG. 1) anchored to the supporting beam, an air cylinder 75 that supports the supporting arm 74, and a mechanical spring (here, a coil spring) 76 serving as an energizing member.

The supporting arm 74 is bent in the middle thereof, and is disposed such that the one end supported by the shaft 74s is directed upward and an intermediate part is directed downward. A first pressing roller 71 is rotatably supported by a shaft 71s at an intermediate bent part. The other end in front of the bent part extends forward in the transport direction of the carton-forming sheet material 10 and slightly downward, and the second pressing roller 72 is rotatably supported by a shaft 72s at the other end.

The pressing rollers 71 and 72 are formed, for example, in a wheel shape having a larger predetermined width than the width (slotter width) of a slotter groove machined in the carton-forming sheet material 10. As materials for the pressing rollers 71 and 72, flexible materials are preferable. For example, a material (for example, NBR-based rubber sponge) formed in a sponge shape or a material having a hollow part for reducing rigidity formed at least in the vicinity of an outer peripheral surface, using NBR-based rubber or polyester-based urethane as a material, is suitable. Here, the polyester-based urethane in which a large number of minute hollow parts 71a and 72a are formed in the vicinity of an outer peripheral surface including both flexibility and durability is applied. Additionally, here, the same rollers are applied to both the pressing rollers 71 and 72.

The first pressing roller 71 is disposed nearest to the delivery rollers 22, and is disposed such that a lower edge thereof slightly enters the transport route of the carton-forming sheet material 10 delivered from between the upper and lower delivery rollers 22, in a state where an external force is not applied. The second pressing roller 72 is spaced apart from the delivery rollers 22 further than the first pressing roller 71, and is disposed such that a lower edge enters the transport route of the carton-forming sheet material 10 slightly more deeply than the first pressing roller 71 in a state where an external force is not applied.

Additionally, the first and second pressing rollers 71 and 72 have a predetermined diameter, and are disposed in close proximity to each other in the transport direction of the carton-forming sheet material 10. For this reason, the first and second pressing rollers 71 and 72 are disposed so as not to interfere with each other and so as to deviate from each other in the device width direction. Here, the first pressing roller 71 is attached to one side (a back side of a sheet plane in FIG. 6) of the supporting arm 74 in the device width direction, and the second pressing roller 72 is attached to the other side (a near side of a sheet plane in FIG. 6) of the supporting arm 74 in the device width direction.

The diameter of the first and second pressing rollers 71 and 72 is secured to a certain extent in consideration of abutment at a shallower angle with respect to outer peripheral surfaces when the leading end of the carton-forming sheet material 10 abuts against outer peripheries of the first and second pressing rollers 71 and 72 as is described below. Additionally, the reason why both the pressing rollers 71 and 72 are disposed in close proximity to each other is that it is considered that each sheet pressing device 70 is desired to be compact, and both the pressing rollers 71 and 72 intensively act on a rear end of the carton-forming sheet material 10 as much as possible when both the pressing rollers 71 and 72 depress the rear end of the carton-forming sheet material 10 as is described below.

A locking part 74a is provided to protrude from the supporting arm 74 on one side (the same side as the transport direction of the carton-forming sheet material 10) above the bent part thereof, and a locking part 74b is provided to protrude from the supporting arm on the other side (a side opposite to the transport direction of the carton-forming sheet material 10) in the vicinity of the one end (upper end). The air cylinder 75 has an upwardly directed cylinder rear end (upper end) rockably locked to the supporting part 24 by a pin 75a, and has a downwardly directed tip part (lower end) rockably locked to the locking part 74a by a pin 75b. Additionally, the mechanical spring 76 also has an upper end rockably locked to a locking hole 76a at the supporting part 24, and has a lower end rockably locked to a locking hole 76b of the locking part 74b.

Additionally, an air-pressure adjusting device 75c that adjusts the air pressure inside the cylinder is connected to the air cylinder 75. The air cylinder 75 can be expanded and compressed through the air-pressure adjusting device 75c. By compressing the air cylinder 75 to move the pin 75b upward, the pressing rollers 71 and 72 can be evacuated upward in the transport route of the carton-forming sheet material 10. In this case, the air-pressure adjusting device 75c functions as evacuation operating means.

The air cylinder 75 holds the supporting arm 74 in a state just before respective lower edges of the pressing rollers 71 and 72 come into contact with the transport route of the carton-forming sheet material 10. That is, the supporting arm 74 has a supporting force applied thereto in a clockwise direction in FIG. 6 by the air cylinder 75, and the pressing rollers 71 and 72 are pulled upward. In this state, since the pressing rollers 71 and 72 do not enter the transport route, the dead weights of the pressing rollers 71 and 72 and the supporting arm 74 are canceled.

Meanwhile, the mechanical spring 76 applies an energizing force to the supporting arm 74 in the counterclockwise direction in FIG. 6 such that the lower edges of the pressing rollers 71 and 72 enter the transport route of the carton-forming sheet material 10. Here, the spring stiffness (spring constant) of the mechanical spring 76 is suppressed to a predetermined level to be described below. In addition, although not illustrated in detail, the position of the locking hole 76a to which an upper end of the mechanical spring 76 is locked can be adjusted upward and downward by an adjuster 77. Thus, the upward and downward positions of the pressing rollers 71 and 72 in a state where an external force is not applied can be adjusted.

In this way, by applying the energizing force of the mechanical spring 76 after the dead weights of the pressing rollers 71 and 72 and the supporting arm 74 are canceled by the air cylinder 75, the spring stiffness of the mechanical spring 76 can be suppressed to be low. It is natural that only one elastic supporting means for elastically supporting the supporting arm 74, such as only the air cylinder 75 or only the mechanical spring 76, may be provided, and the pressing rollers 71 and 72 may be brought to predetermined upward and downward positions in a state where an external force is not applied. In this case, the spring stiffness (spring constant) of the elastic supporting means should be secured to a certain degree. As a result, although the reaction forces of the pressing rollers 71 and 72 when the leading end of the carton-forming sheet material 10 abuts is liable to increase, the reaction forces can be adjusted.

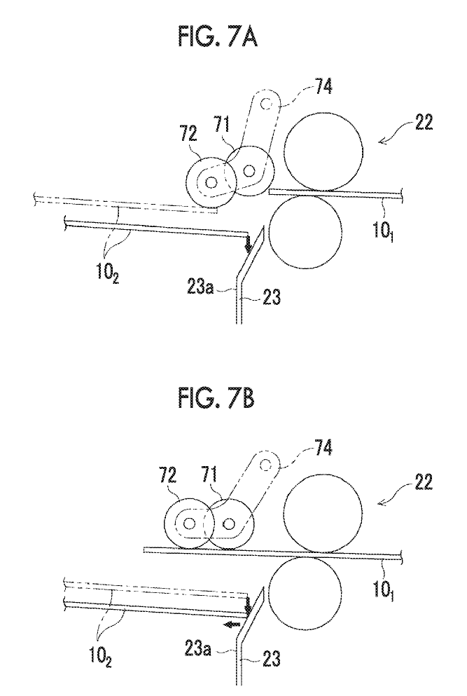

Accordingly, as illustrated in FIG. 7A, the respective lower edge of the pressing rollers 71 and 72 enter the transport route of the carton-forming sheet material 10 with the energizing force of the mechanical spring 76 until the leading end of the carton-forming sheet material 10₁ delivered by the delivery rollers 22 approaches the pressing roller 71. Here, the amount of entering of a lower edge of the first pressing roller 71 into the transport route of the carton-forming sheet material 10 is minor. In addition, since two carton-forming sheet materials 10 are illustrated in FIG. 7A and FIG. 7B, when these materials are distinguished from each other, one carton-forming sheet material (here, a subsequent side) 10 is designated by reference sign 10₁, and the other carton-forming sheet material 10 (here, a preceding side) is designated by reference sign 102.

If the leading end of the carton-forming sheet material 10₁ approaches the first pressing roller 71, first, the leading end abuts against the first pressing roller 71. Since the carton-forming sheet material 10₁ is sandwiched and supported by the upper and lower delivery rollers 22, the carton-forming sheet material 10₁ travels on a predetermined transport route, and since the amount of the lower edge of the first pressing roller 71 entering into the transport route of the carton-forming sheet material 10 is small, the leading end of the carton-forming sheet material 10₁ abuts against the lower edge of the first pressing roller 71 at a shallow angle, and travels to push the first pressing roller 71 upward.

In this case, the reaction force caused by the energizing force of the mechanical spring 76 is applied to the leading end of the carton-forming sheet material 10₁. However, the spring stiffness of the mechanical spring 76 is suppressed to a predetermined level, that is, to such a level that the leading end of the carton-forming sheet material 10₁ is neither deformed nor damaged. Thus, the leading end of the carton-forming sheet material 10₁ is transported without being influenced by the first pressing roller 71. Additionally, the first pressing roller 71 has an outer peripheral surface, coming into contact with the carton-forming sheet material 10₁, formed in a flexible manner and is smoothly rotated in a following manner with the movement of the carton-forming sheet material 10₁. Thus, the leading end of the carton-forming sheet material 10₁ is also transported without being damaged from this point of view.

If the leading end of the carton-forming sheet material 10₁ travels, the leading end abuts against the second pressing roller 72. However, in a stage where the first pressing roller 72 is pushed upward, the second pressing roller 72 is also pushed upward and the amount of the lower edge of the second pressing roller 71 entering into the transport route of the carton-forming sheet material 10 is small. Thus, as illustrated in FIG. 7B, the leading end of the carton-forming sheet material 10₁ abuts against a lower edge of the second pressing roller at a shallow angle and travels to push the second pressing roller 72 upward.

Even in this case, a reaction force caused by the energizing force of the mechanical spring 76 is applied to the leading end of the carton-forming sheet material 10₁. However, similar to the above, the spring stiffness of the mechanical spring 76 is suppressed to such a predetermined level that the leading end of the carton-forming sheet material 10₁ is neither deformed nor damaged. Thus, the leading end of the carton-forming sheet material 10₁ is transported without being influenced by the first pressing roller 71. Additionally, similar to the above, the second pressing roller 72 has an outer peripheral surface, coming into contact with the carton-forming sheet material 10₁, formed in a flexible manner and is smoothly rotated in a following manner with the movement of the carton-forming sheet material 10₁. Thus, the leading end of the carton-forming sheet material 10₁ is also transported without being damaged from this point of view.

As a result, the carton-forming sheet material 10₁ travels in a state where the mechanical spring 76 is deformed in a compressed manner by an amount equivalent to two-stage compression and the first and second pressing rollers 71 and 72 are pushed upward. However, if the rear end of the carton-forming sheet material 10₂ slips out of the upper and lower delivery rollers 22 afterward like the carton-forming sheet material 10₂ illustrated in FIG. 7A, the carton-forming sheet material 10₂ becomes free. Thus, the energizing force of the mechanical spring 76 that is deformed in a compressed manner is exhibited, and the rear end of the carton-forming sheet material 10₂ is depressed from a state illustrated by a two-dot chain line to a state illustrated by a solid line.

In this way, as illustrated in FIGS. 5A to 5D, the leading end of the carton-forming sheet material 10₂ of which the rear end is depressed abuts against a flexible stop plate 28a of the front stopper 28. However, since the flexible stop plate 28a is flexible, the flexible stop plate 28a stops movement of the carton-forming sheet material 10₂ while being bent. However, since the carton-forming sheet material 10₂ is moved backward while being lifted due to the reaction thereof after the leading end thereof abuts against the flexible stop plate 28a, as illustrated in FIG. 7A, the rear end of the carton-forming sheet material 10₂ is moved backward while being lowered.

In this case, the rear end of the carton-forming sheet material 10₂ is lowered while being moved backward so as to approach the abutting surface 23a of the spanker 23. However, the upper part of the abutting surface 23a is inclined such that an upper end thereof shifts rearward in the transport direction of the carton-forming sheet material 10. Thus, the rear end of the carton-forming sheet material 10₂, which is lowered while being moved backward, reliably abuts against the upper part of the abutting surface 23a and is lowered while being guided by the abutting surface 23a.

### Working and Effects

Since the sheet layering device 60 related to the present embodiment is configured as described above, the carton-forming sheet material 10 is layered into hopper unit H, for example, as illustrated in FIGS. 8A to 8F. In addition, as illustrated by a white arrow AF in FIGS. 8A to 8F, air is blown against a rear part and a front part in the transport direction within the hopper unit H downward from above by the blowing devices 52 and 53 to promote the lowering of the carton-forming sheet material 10.

That is, as illustrated in FIG. 8A, when the carton-forming sheet material 10 is delivered from the delivery rollers 22 to a space above the hopper unit H along the horizontal or substantially horizontal transport route, first, the leading end of the carton-forming sheet material 10 approaches the first pressing roller 71. In this state, the respective lower edges of the pressing rollers 71 and 72 enter the transport route of the carton-forming sheet material 10 with the energizing force of the mechanical spring 76.

If the leading end of the carton-forming sheet material 10 abuts against the first pressing roller 71, the carton-forming sheet material 10 is sandwiched and supported by the upper and lower delivery rollers 22. Thus, the carton-forming sheet material 10 travels on the predetermined transport route. Since the amount of the lower edge of the first pressing roller 71 entering into the transport route of the carton-forming sheet material 10 is small, the leading end of the carton-forming sheet material 10 abuts against the lower edge of the first pressing roller 71 at a shallow angle, and travels to push the first pressing roller 71 upward.

If the leading end of the carton-forming sheet material 10 travels further, the leading end abuts against the second pressing roller 72. However, since the first pressing roller 72 is pushed upward, the second pressing roller 72 is also pushed upward and the amount of the lower edge of the second pressing roller 72 entering into the transport route of the carton-forming sheet material 10 is small. For this reason, as illustrated in FIG. 8B, the leading end of the carton-forming sheet material 10 abuts against the lower edge of the second pressing roller at a shallow angle and travels to push the second pressing roller 72 upward.

The carton-forming sheet material 10 travels as illustrated in FIG. 8C in a state where the first and second pressing rollers 71 and 72 are pushed upward while the mechanical spring 76 is deformed in a compressed manner by an amount equivalent to compression in two stages including a stage where the first pressing roller 72 is pushed upward and a stage where the second pressing roller 72 is pushed upward. However, if the rear end of the carton-forming sheet material 10 slips out of the upper and lower delivery rollers 22, the carton-forming sheet material 10 become free. Thus, the energizing force of the mechanical spring 76 that is deformed in a compressed manner is exhibited, and as illustrated in FIG. 8D, the rear end of the carton-forming sheet material 10 is depressed by the first and second pressing rollers 71 and 72.

If there is no depression of the rear end of the carton-forming sheet material 10 by the first and second pressing rollers 71 and 72, the carton-forming sheet material 10 is lowered on the leading end side thereof and tilted forward like carton-forming sheet material 10′ illustrated by a two-dot chain line in FIG. 8D due to the blowing of air by the blowing devices 52 and 53 and the dead weight thereof. If the preceding carton-forming sheet material 10 is inclined forward, stacking cannot be appropriately performed such that the preceding carton-forming sheet material 10 falls into the hopper unit H in this posture and the subsequent carton-forming sheet material 10 cannot be appropriately layered or such that a leading end of the subsequent carton-forming sheet material 10 collides against a rear end of the preceding carton-forming sheet material 10 (back push). Particularly, if this forward inclination becomes larger in the case of the carton-forming sheet material 10 having a length in the transport direction, there is also a concern that the carton-forming sheet material 10 may abut against a high-rigidity stop plate 28b below the flexible stop plate 28a of the front stopper 28 and the leading end may be damaged or deformed.

If the rear end of the carton-forming sheet material 10 is depressed by the first and second pressing rollers 71 and 72, such forward inclination of the carton-forming sheet material 10 is avoided, the carton-forming sheet material 10 moves forward in a substantially horizontal posture, and abuts against the flexible stop plate 101 of the front stopper 28. The flexible stop plate 101 absorbs the kinetic energy of the carton-forming sheet material 102 to stop its movement while being flexed.

Then, the flexible stop plate 101 moves the carton-forming sheet material 10 backward in the direction opposite to the transport direction with the restoring force thereof after being elastically deformed in a state the leading end of the carton-forming sheet material 10 abuts thereagainst. However, since a portion of the restoring force acts upward due to the inclination of the flexible stop plate 101, as illustrated in FIG. 8E, the carton-forming sheet material 10 is moved backward while being lowered in a posture in which the leading end thereof is raised. In this case, the rear end of the carton-forming sheet material 10₂ is lowered while facing the abutting surface 23a of the spanker 23. However, since the upper part of the abutting surface 23a is inclined, the rear end of the carton-forming sheet material 10, which is lowered while being moved backward, reliably abuts against the upper part of the abutting surface 23a, and is lowered as illustrated in FIG. 8F while being guided by the abutting surface 23a.

In this way, in a case where the carton-forming sheet material 10 is inclined forward and collides against the flexible stop plate 101, a vertical component of the restoring force of the flexible stop plate 101 corrects the inclination of the carton-forming sheet material 10. Thus, a concern is avoided that the front end of the subsequent carton-forming sheet material 10 may collide against the rear end of the carton-forming sheet material 10 stopped by the front stopper 28 and may cause a damage such that each carton-forming sheet material 10 bends or that jamming of a layering part may be caused and the carton-forming sheet material 10 cannot be appropriately stacked.

Particularly, the elastic-deformation-allowing space 107 where the flexible stop plate 101 side of the supporting base 28B is largely formed in a concave shape and the elastic deformation of the flexible stop plate 101 is allowed is secured. Thus, the kinetic energy of the carton-forming sheet material 10 can be absorbed while suppressing the rigidity of the flexible stop plate 101 to largely deform the flexible stop plate 101, and a concern that the carton-forming sheet material 10 may collide against the flexible stop plate 101 to deform or damage the flexible stop plate 101 can be further reduced.

In the energy at the time when the carton-forming sheet material 10 collides against the flexible stop plate 101, an elastic energy component the flexible stop plate 101 is increased and the restoring force F of the flexible stop plate 101 becomes larger, as much as the carton-forming sheet material 10 is not deformed or damaged. As a result, the carton-forming sheet material 10 is easily pushed back to a side opposite to the transport direction with a large restoring force F and hinders appropriate stacking of the carton-forming sheet material 10. However, this push-back force is reduced as much as a portion of the restoring force F acts on the carton-forming sheet material 10 upward, and the carton-forming sheet material 10 is easily stacked appropriately.

In this way, the carton-forming sheet material 10 is appropriately layered while holding a substantially horizontal posture, and the appropriate stack 50 is layered by a predetermined number of sheets and a batch is formed and discharged.

Additionally, the pressing rollers 71 and 72 are rotated in a following manner in a movement direction of the carton-forming sheet material 10 as peripheral surfaces thereof come into contact with the carton-forming sheet material 10. Thus, a mechanism that rotationally drives the pressing rollers 71 and 72 is unnecessary, complication or cost increase of the device can be suppressed, and a concern that the carton-forming sheet material 10 may be worn and damaged or soiled by the outer peripheral surfaces of the pressing rollers 71 and 72 is also suppressed.

Additionally, the pressing rollers have the first pressing roller 71 and the second pressing roller 72, and if the first pressing roller 71 is moved upward in the transport route while the carton-forming sheet material 10 abuts and the mechanical spring 76 is compressed, the second pressing roller 72 shifts to an upper side within the transport route. Thereafter, as, the carton-forming sheet material 10 abuts against the second pressing roller, the second pressing roller 72 is moved upward in the transport route while the mechanical spring 76 is further compressed.

For this reason, the elastic energy caused by the compression can be accumulated in the mechanical spring 76 without suddenly giving a compression reaction force of the mechanical spring 76 to the carton-forming sheet material 10. Hence, the posture of the carton-forming sheet material 10 can be reliably corrected by accumulating large elastic energy in the mechanical spring 76 to strongly push in the rear end of the carton-forming sheet material 10 while suppressing generation of damage to or dirt of the carton-forming sheet material 10.

Here, at least one pressing roller may be provided or three or more pressing rollers may be disposed side by side in the transport direction.

Additionally, since a plurality of the sheet pressing devices 70 are provided in the device width direction, the posture of the sheet pressing devices 70 can be reliably corrected by pushing in the rear end of the carton-forming sheet material 10 without deviating in the width direction. In addition, in the present embodiment, the two sheet pressing devices 70 are provided in the device width direction. However, three or more sheet pressing devices may be provided. Additionally, only one sheet pressing device 70 may be provided as long as the width of the pressing rollers is sufficient.

Additionally, in the present embodiment, the supporting member 73 that supports the pressing rollers 71 and 72 is configured to have the supporting arm 74, the air cylinder 75, and the mechanical spring 76, the dead weights of the pressing rollers 71 and 72 and the supporting arm 74 are cancelled by the air cylinder 75, and the lower edge of the pressing rollers 71 and 72 is operated by the mechanical spring 76 so as to enter the transport route of the carton-forming sheet material 10. Thus, the position of the pressing rollers 71 and 72 can be operated while making the spring stiffness of the mechanical spring 76 small, and when the leading end of the carton-forming sheet material 10 abuts against the lower edges of the pressing rollers 71 and 72, a reaction force caused by the mechanical spring 76 can be suppressed, and damage or the like to the leading end of the carton-forming sheet material 10 can be suppressed.

Moreover, the pressing rollers 71 and 72 are formed of a relatively flexible material referred to as polyester-based urethane and the hollow parts 71a and 72a for reducing rigidity are formed in the vicinity of the peripheral surfaces. Thus, from this point of view, it is also possible to suppress damage or the like to the leading end of the carton-forming sheet material 10 where the carton-forming sheet material 10 abuts against the pressing rollers 71 and 72, an upper surface of the carton-forming sheet material 10 on which the pressing rollers 71 and 72 roll, or the like. In addition, it is preferable that the pressing rollers 71 and 72 are made of a flexible lightweight material capable of softly coming into contact with the carton-forming sheet material 10. However, in this regard, a rubber-based material or resin-based material is suitable.

Additionally, in the present embodiment, the blowing devices 52 and 53 blow air against the carton-forming sheet material 10 from above. Thus, the carton-forming sheet material 10 is rapidly lowered within the hopper unit H, and the stack 50 is easily formed appropriately. On the other hand, if the speed of air or the setting of a blowing is not appropriate, a concern that the carton-forming sheet material 10 may be inclined forward occurs. However, such a concern is solved by the sheet pressing device 70 as described above.

In addition, in the case of a size such that it is not necessary to push the rear end, it is preferable to make the air-pressure adjusting device 75c function as the evacuation operating means and to evacuate the pressing rollers 71 and 72 upward in the transport route of the carton-forming sheet material 10. That is, by compressing the air cylinder 75 with the air-pressure adjusting device 75c to move the pin 75b upward, the pressing rollers 71 and 72 can be evacuated upward in the transport route of the carton-forming sheet material 10. Accordingly, unnecessary contact of the pressing rollers 71 and 72 with the carton-forming sheet material 10 is avoided, and wear of the pressing rollers 71 and 72 is also avoided.

Moreover, the air cylinder 75 may be appropriately expanded and compressed by the air-pressure adjusting device 75c on the basis of the size, thickness, or speed of the carton-forming sheet material 10 so as to adjust the position of the pressing rollers 71 and 72 to an optimal position. For example, if the size of the carton-forming sheet material 10 is not so large, it is originally difficult to incline the carton-forming sheet material 10 forward. Thus, the positions of the pressing rollers 71 and 72 are adjusted such that a pressing stroke is shortened or the pressing itself is not performed.

Additionally, in a case where the thickness of the carton-forming sheet material 10 is large, the positions of the pressing rollers 71 and 72 are adjusted such that the collision of the carton-forming sheet material 10 against the pressing rollers 71 and 72 is made lighter. Additionally, if the speed of the carton-forming sheet material 10 is slow, the layering intervals (the temporal transport interval of the corrugated fiberboard delivered to the hopper unit) is empty, and the time for which the carton-forming sheet material 10 falls into the hopper unit H is sufficient. Thus, the positions of the pressing rollers 71 and 72 are adjusted such that a pressing stroke is shortened or the pressing itself is not performed. Accordingly, unnecessary contact of the pressing rollers 71 and 72 with the carton-forming sheet material 10 is avoided or reduced, and wear of the pressing rollers 71 and 72 is also avoided.

Additionally, since the width of the pressing rollers 71 and 72 is set to be larger than the slotter width, the pressing rollers 71 and 72 are not caught in the slotter groove, and the pressing rollers 71 and 72 can be excellently brought into contact with and pressed against the carton-forming sheet material 10.

Additionally, although reference is not made in the above embodiment, as illustrated in FIG. 3, the front stopper 28 is split in the width direction in order to avoid any interference with other members. However, an angle α may be separately set for each split portion.

### Second Embodiment

Next, a front stopping device related to a second embodiment is described.

A carton former of the second embodiment is configured similarly to the first embodiment except for the front stopping device. In addition, the same signs in FIGS. 9A to 9C as those in FIG. 4 represent the same components, and the description thereof is omitted.

As illustrated in FIGS. 9A to 9C, similar to the first embodiment, the front stopper 28 related to the present embodiment has the flexible stop plate (plate-shaped buffering member) 101 that comes into direct contact with the front part of the carton-forming sheet material 10, and the high-rigidity stop plate 102 that is formed substantially continuously below the flexible stop plate 101. The flexible stop plate 101 has the upper and lower ends supported by the supporting members 103 and 104.

In the present embodiment, the supporting members 103 and 104 are supported by supporting bases 28A and 28B via a movable supporting member 203. That is, as illustrated in FIG. 9C, a lower end of the movable supporting member 203 is turnably supported by the supporting base 28B via a pin 204, and as illustrated in FIG. 9A, an upper end of the movable supporting member 203 is turnably supported by the supporting base 28B via a pin 205 inserted through a circular-arc elongated hole 206 formed in the supporting base 28B, and the supporting members 103 and 104 are fixed to the movable supporting member 203. In addition, the supporting base 28B is fastened to a supporting base 28A with a bolt 28c. Additionally, the same signs in FIGS. 9A to 9C as those in FIG. 4 represent the same components, and the description thereof is omitted.

A back surface of the movable supporting member 203 is provided with an inclination angle adjusting mechanism 200A that adjusts the angle of the movable supporting member 203 to adjust the inclination angle of the flexible stop plate 101. The inclination angle adjusting mechanism 200A includes an angle adjusting bolt (manual operation means) 210 of which a tip abuts against the back surface of the movable supporting member 203, a screw hole 212 of the supporting base 28A, and a fixing nut 211.

Since the angle adjusting bolt 210 is threadedly engaged with the screw hole 212 of the supporting base 28A, an axial position thereof can be changed by rotationally operating the angle adjusting bolt 210. In addition, the movable supporting member 203 is brought into pressure contact with the angle adjusting bolt 210 by an energizing mechanism (not illustrated). Thus, if the angle adjusting bolt 210 moves forward, the inclination of the movable supporting member 203 becomes smaller. As a result, the inclination angle α of the flexible stop plate 101 also becomes smaller. If the angle adjusting bolt 210 moves backward, the inclination of the movable supporting member 203 becomes larger. As a result, the inclination angle α of the flexible stop plate 101 also becomes larger. In addition, if the axial position of the angle adjusting bolt 210 is adjusted, the fixing nut 211 is fastened to fix the axial position of the angle adjusting bolt 210.

According to the present embodiment, by rotationally operating the angle adjusting bolt 210 to change the axial position of the angle adjusting bolt 210, it is possible to adjust the angle of the movable supporting member 203 to adjust the inclination angle α of the flexible stop plate 101. Thus, the inclination angle α of the flexible stop plate 101 can be set according to the characteristics of the carton-forming sheet material 10, the ratio of the vertical component and the horizontal component of the restoring force can be adjusted, and the posture of the carton-forming sheet material 10 can be optically corrected.

### Third Embodiment

Next, a front stopping device related to a third embodiment will be described.

The front stopping device of the third embodiment is different from that of the second embodiment in terms of an inclination angle adjusting mechanism 200B that adjusts the angle of the movable supporting member 203 to adjust the inclination angle of the flexible stop plate 101. The inclination angle adjusting mechanism 200B of the present embodiment includes a motor (electric motor) 220 serving as an actuator, and a rod 221 of which a tip abuts against the back surface of the movable supporting member 203 and which is driven to be moved forward and backward by the motor 220. In addition, the same signs in FIG. 10 as those in FIGS. 9A to 9C represent the same components, and the description thereof will be omitted.

In addition, the motor 220 is a rotary motor, and is provided with a mechanism that converts a rotational motion into a linear motion in order to move the rod 221 forward and backward. As this converting mechanism, various mechanisms can be applied. The bolt threadedly engaged with the fixed screw hole may be applied to the rod 221 as in the inclination angle adjusting mechanism 200A related to the second embodiment, and the rod 221 may be rotated by the motor 220, or a rack and a pinion may be applied, the rack may be anchored to the rod 221, and the pinion may be rotationally driven by the motor 220.

In addition, the movable supporting member 203 has its back surface brought into pressure contact with the rod 221 by an energizing mechanism (not illustrated). Thus, if the rod 221 moves forward, the inclination of the movable supporting member 203 becomes smaller. As a result, the inclination angle α of the flexible stop plate 101 also becomes smaller. If the rod 221 moves backward, the inclination of the movable supporting member 203 becomes larger. As a result, the inclination angle α of the flexible stop plate 101 also becomes larger.

In the present embodiment, a control device (control means) 230 is provided to control the motor 220 according to the type of the carton-forming sheet material 10 and the processing conditions of the carton-forming sheet material 10 and set the inclination angle α of the flexible stop plate 101 to a suitable magnitude. If the type of the carton-forming sheet material 10 and the processing conditions of the carton-forming sheet material 10 are input to the control device 230, the control device 230 automatically presets the inclination angle of the flexible stop plate 101.

According to the present embodiment, the inclination angle of the flexible stop plate 101 can be automatically preset, an operator's burden can be alleviated, adjustment time can be shortened, and production efficiency can be improved.

Additionally, as illustrated in FIG. 3, the front stopper 28 is formed to be split in the width direction. However, the inclination angle adjusting mechanism 200A or 200B may be provided for each split portion so as to individually adjust the angle α of the flexible stop plate 101. Each portion of the flexible stop plate 101 can be set to an appropriate inclination angle according to the behavioral characteristics of the carton-forming sheet material 10, and the posture of the flexible stop plate 101 can be appropriately corrected.

Additionally, an interlocking mechanism may be provided to integrally interlock the respective flexible stop plates 101 of the front stopper 28 formed to be split in the width direction with each other, and may be configured to be capable of adjusting the inclination angles of the respective flexible stop plates 101 in an interlocking manner.

Accordingly, the adjustment time can be shortened, and the production efficiency can be improved.

### Fourth Embodiment

Here, a configuration in which a plurality of front stopping devices are interlocked with each other by an interlocking mechanism will be specifically described as a fourth embodiment with reference to FIGS. 11A and 11B. In addition, the same signs in FIGS. 11A and 11B as those in FIGS. 9A to 9C represent the same components, and the description thereof will be omitted.

As illustrated in FIGS. 11A and 11B, the front stopping device of the present embodiment is different from that of the second and third embodiments in terms of the inclination angle adjusting mechanism 200B that adjusts the angle of the movable supporting member 203 to adjust the inclination angle of the flexible stop plate 101. As illustrated in FIG. 11B, a plurality of the front stoppers 28 are juxtaposed and provided side by side in a direction orthogonal to the transport direction of the carton-forming sheet material 10, and each front stopper is provided with an inclination angle adjusting mechanism 200C illustrated in FIG. 11A.

The inclination angle adjusting mechanism 200C of the present embodiment includes an angle adjusting rod 240 of which a tip abuts against the back surface of the movable supporting member 203, and a cam mechanism 250 that moves the angle adjusting rod 240 forward and backward. The angle adjusting rod 240 is supported by the supporting base 28A so as to be movable forward and backward in a direction in which the back surface of the movable supporting member 203 is pressed by the tip of the angle adjusting rod. In addition, an energizing mechanism (not illustrated) is provided to energize the movable supporting member 203 to the angle adjusting rod 240 side, and the back surface of the movable supporting member 203 is always brought into pressure contact with the angle adjusting rod 240.

The cam mechanism 250 includes a cam 251, a camshaft 252 that supports the cam 251, and an operating lever (manual operation means) 253 that rotationally operates the camshaft 252. A base end of the angle adjusting rod 240 is provided with an actuating pin 241 that abuts against a cam surface 251a of the cam 251 to actuate the angle adjusting rod 240 forward and backward.

The camshaft 252 is provided as one interlocking shaft that moves the angle adjusting rods 240 of the inclination angle adjusting mechanisms 200C of the respective front stoppers 28 forward and backward in an interlocking manner. The camshaft 252 is provided to be rotatably supported by a frame 28F that supports the supporting base 28A, and the operating lever 253 is provided outside the frame 28F at one end of the camshaft 252. Additionally, a locking mechanism 254 that locks the rotation of the camshaft 252 is provided adjacent to the operating lever 253 outside the frame 28F.

According to the inclination angle adjusting mechanism 200C of the present embodiment, as an operator releasing the locking mechanism 254 to operate the operating lever 253, the angle adjusting rods 240 of the inclination angle adjusting mechanisms 200C of the respective front stoppers 28 can be moved forward and backward in an interlocking manner, the inclination angles of the flexible stop plates 101 can be simultaneously set, the operator's burden can be alleviated, the adjustment time can be shortened, and the production efficiency can be improved.

In addition, the camshaft 252 serving as the interlocking shaft of the inclination angle adjusting mechanism 200C of the present embodiment may be rotationally driven by an actuators, such as an electric motor, such that this actuator is actuated by a switch operation, and the locking mechanism 254 may also be provided with an actuator that performs locking and unlocking such that this actuator is actuated by a switch operation. Accordingly, the operator's burden can be further mitigated.

Moreover, if the type of the carton-forming sheet material 10 and the processing conditions of the carton-forming sheet material 10 are input to the control device 230 by further providing the control device (control means) 230 illustrated in the third embodiment so as to control the actuator of the inclination angle adjusting mechanism 200C and the actuator of the locking mechanism 254, the control device 230 may be configured so as to automatically preset the inclination angle α of the flexible stop plate 101 to a suitable state.

Additionally, the interlocking mechanism is realized even if the inclination angle adjusting mechanism 200B illustrated in the third embodiment is applied to each of the plurality of front stopping devices and the inclination angle adjusting mechanisms 200B of the respective front stoppers 28 are operated in an interlocking manner by one control device 230.

In the case illustrated in the third embodiment, according to commands to the respective inclination angle adjusting mechanisms 200B by the control device 230, the respective inclination angle adjusting mechanisms 200B can be individually actuated or may be actuated in an interlocking manner. For example, if the rotational amounts given to the motors 220 of the respective inclination angle adjusting mechanisms 200B by the control device 230 as commands are made equal to each other, the inclination angle adjusting mechanisms 200B can be actuated in an interlocking manner, and if the rotational amounts given to the respective motors 220 as commands are individual, the inclination angle adjusting mechanisms 200B can be individually actuated.

[Others]

Although the embodiments of the invention have been described above, the invention is not limited to the above-described respective embodiments, and alternations, omissions, and combinations can be appropriately carried out without departing from the spirit of the invention.

That is, in the above embodiment, the flexible stop plate 101 is inclined upward from the vertical direction supposing a case where the leading end of the sheet (carton-forming sheet material) 10 abuts against the front stopper in a lowered posture. In the case of a short sheet, however, it is also possible to assume a case where the leading end of the sheet 10 abuts against the front stopper in a lifted posture, and as a countermeasure against this assumption, the flexible stop plate 101 may be inclined downward.

Additionally, in the above embodiment, as a device that can contribute to the posture correction of the sheet 10, there are the fixed fans (fixed blowing devices) 52, the movable fans (movable blowing devices) 53, and the sheet pressing device 70 in addition to the front stopping device 28, and these are appropriately combined together and used. However, if the inclination angle of the flexible stop plate 101 of the front stopping device 28 is constant, it is also effective to change and use combinations of actuation and non-actuation of the respective devices according to the characteristics of the sheet 10.

For example, in the case of a sheet in which the inclination angle α of the flexible stop plate 101 is fixed to a small value, and thus the hanging-down on the leading end side of the sheet 10 is not sufficiently eliminated even if an upward reaction force is given by the flexible stop plate 101, it is also effective to stop or weaken the movable fans 53 on the leading end side of the sheet 10. On the contrary, if the upward reaction force is too large by the flexible stop plate 101, it is also effective to strengthen the movable fans 53 on the leading end side.

Additionally, in the above embodiment, the control device (control means) 230 is provided to control the motor 220 according to the type of the carton-forming sheet material 10 and the processing conditions of the carton-forming sheet material 10 and set the inclination angle α of the flexible stop plate 101 to a suitable magnitude. If the type of the carton-forming sheet material 10 and the processing conditions of the carton-forming sheet material 10 are input to the control device 230, the control device 230 automatically presets the inclination angle of the flexible stop plate 101. However, the operator may set the inclination angle to an arbitrary inclination angle.

For example, in a case where an operator confirms the posture of the carton-forming sheet material 10 within the hopper unit H during the operation of the carton former and determines that a preset inclination angle is not suitable, the operator inputs an arbitrary inclination angle to the control device 230. On the basis of the input inclination angle, the control device 230 controls the inclination angle adjusting mechanism 200B to adjust the inclination angle of the flexible stop plate 101. Accordingly, since the inclination angle of the flexible stop plate 101 can be adjusted, without stopping the carton former, the production efficiency can be improved.

Additionally, the sheet layering device related to the invention may have at least the hopper unit H, the delivery rollers 22, and the front stopper 28, and for example, the sheet pressing devices may be omitted. Additionally, the blowing devices may also be omitted.

Additionally, a target to be stopped by the front stopping device or a sheet to be layered by the sheet layering device related to the invention is not limited to the carton-forming sheet material 10, and for example, arbitrary plate-shaped sheets having constant rigidity, such as a simple corrugated fiberboard, may be targets to be layered. Hence, the sheet layering device related to the invention can be applied to those other than the counter-ejector section of the carton former.

It is natural that the specific configurations of the respective parts of the counter-ejectors and the carton formers illustrated in the above-described respective embodiments are also exemplary, and these configurations can also be altered without departing from the spirit of the invention.

### REFERENCE SIGNS LIST

1: SHEET FEEDING SECTION
2: PRINTING SECTION
3: SLOTTER CREASER SECTION
4: DIE-CUT SECTION
5: FOLDER-GLUER SECTION
6: COUNTER-EJECTOR SECTION (COUNTER-EJECTOR)
10,10₁,10₂: SHEET-LIKE CORRUGATED CARTON (CARTON-FORMING SHEET MATERIAL, SHEET)
10a: CORRUGATED FIBERBOARD
20: FRAME
21: ROLLER FOR CONVEYOR
22: DELIVERY ROLLER
23: SPANKER
23a: ABUTTING SURFACE
24: SUPPORTING PART
27: PUSHER
28: FRONT STOPPER (FRONT STOPPING DEVICE)
28a, 28b: SUPPORTING BASE
32: ELEVATOR
33a: RACK
33b: PINION
34: SUPPORTING SHAFT
35: SERVO MOTOR
36: SIDE FRAME
37: RAIL
38: LEDGE SUPPORT
39: ROLLER
40: LEDGE BACK-AND-FORTH SERVO MOTOR
41: LIFTING MECHANISM
42: LEDGE
44: PRESS BAR
47: LOWER CONVEYOR
47a: SERVO MOTOR FOR LOWER CONVEYOR
48: DISCHARGE CONVEYOR
48a: SERVO MOTOR FOR DISCHARGE CONVEYOR
49: UPPER CONVEYOR
49a: MOVING MECHANISM
50, 50a: STACK
52: FIXED FAN (FIXED BLOWING DEVICE)
53: MOVABLE FAN (MOVABLE BLOWING DEVICE)

1. A front stopping device that receives a front part of a sheet delivered to a space above a hopper unit along a horizontal or substantially horizontal transport route by a delivery roller and stops movement of the sheet in a transport direction, the front stopping device comprising:
a plate-shaped buffering member that is brought into direct contact with the front part of the sheet; and
a supporting member that supports an upper end and a lower end of the buffering member,
wherein the buffering member is formed of a flexible material to absorb the kinetic energy of the sheet by being elastically deformed in a concave surface shape when receiving the front part of the sheet, and
wherein the buffering member is supported by being inclined upward or downward by the first supporting member such that a restoring force of pushing back the front part of the sheet due to the restoration of the elastic deformation includes a vertical component.

2. The front stopping device according to claim 1,
wherein the buffering member is supported by being inclined vertically upward by the first supporting member.

3. The front stopping device according to claim 1,
wherein the buffering member includes
a plate-shaped elastic member that is brought into direct contact with the front part of the sheet, and
a flat spring that is disposed on a back surface of the elastic member and is deformed together with the elastic member at the time of deformation of the elastic member.

4. The front stopping device according to claim 1,
wherein a deformation-allowing space that allows elastic deformation caused by the collision of the sheet is provided on the back surface of the buffering member.

5. The front stopping device according to claim 1,
wherein the buffering member is fixed at a predetermined inclination angle by the first supporting member.

6. The front stopping device according to claim 1,
wherein the first supporting member is provided with an inclination angle adjusting mechanism that adjusts an inclination angle of the buffering member.

7. The front stopping device according to claim 6,
wherein the inclination angle adjusting mechanism includes
a supporting shaft that supports one of the upper end and the lower end of the buffering member so as to be turnable around an axis that is orthogonal to the transport direction, and is horizontal, and
a moving mechanism that moves the other end of the upper end and the lower end of the buffering member in the transport direction.

8. The front stopping device according to claim 6,
wherein the inclination angle adjusting mechanism includes manual operation means for moving a main part of the buffering member.

9. The front stopping device according to claim 6,
wherein the inclination angle adjusting mechanism includes an actuator that moves a main part of the buffering member.

10. The front stopping device according to claim 9, further comprising:
control means for controlling the actuator according to input of the type of sheet and processing conditions of the sheet and automatically sets the inclination angle of the buffering member.

11. The front stopping device according to claim 6,
wherein the buffering member is split into a plurality of portions in a device width direction, and
wherein inclination angle adjusting mechanisms are individually provided at the respective split portions.

12. The front stopping device according to claim 6,
wherein the buffering member is split into a plurality of portions in a device width direction, and
wherein an interlocking mechanism is provided to be capable of integrally interlocking the respective split portions with each other to adjust the inclination angle using the inclination angle adjusting mechanism.

13. A sheet layering device comprising:
a hopper unit that layers a sheet horizontally or substantially horizontally;
a delivery roller that delivers the sheet to a space above the hopper unit along a horizontal or substantially horizontal transport route; and
a front stopper part that receives a front part of a sheet delivered by the delivery roller to stop movement of the sheet in a transport direction,
wherein the front stopper part is provided with the front stopping device according to claim 1.

14. The sheet layering device according to claim 13, further comprising:
a sheet pressing device that suppresses a rear part of the sheet delivered by the delivery roller downward,
wherein the sheet pressing device includes
a pressing roller that is disposed downstream of the delivery roller, comes into contact with the sheet, and rotates together with the movement of the sheet, and
a second supporting member that supports the pressing roller so as to be rockable between the inside of the transport route and a space above the transport route.

15. The sheet layering device according to claim 13, further comprising:
a blowing device that is disposed above the hopper unit and blows air against the sheet delivered by the delivery roller downward from above.

16. The sheet layering device according to claim 13,
wherein the sheet is a sheet-like corrugated carton.

17. A counter-ejector comprising:
the sheet layering device according to claim 16, which is provided at a downstream part of a carton former,
the counter-ejector layers a sheet-like corrugated carton, which is transported and delivered from an upstream side, on the hopper unit, while counting the sheet-like corrugated carton.

18. A carton former comprising:
a sheet feeding section that feeds corrugated fiberboards one by one;
a printing section that performs printing on a corrugated fiberboard fed from the sheet feeding section;
a slotter creaser section that discharges the corrugated fiberboard printed by the printing section;
a die-cut section that performs grooving and ruling on the corrugated fiberboard discharged from the slotter creaser section;
a folder-gluer section that performs gluing and bending on an end of the corrugated fiberboard processed by the die-cut section to form a sheet-like corrugated carton; and
a counter-ejector section that layers the corrugated carton processed by the folder-gluer section while counting the corrugated carton,
wherein the counter-ejector section is provided with the counter-ejector according to claim 17.
